(19) United States
(12) Patent Application Publication
(10) Pub. No.: US 2007/0068126 A1
(43) Pub. Date: Mar. 29, 2007

(54) Cartridge filter spinner

(76) Inventor: Juris Terauds, Olivenhain, CA (US)

Correspondence Address: JURIS TERAUDS, 3319 LONE JACK ROAD, OLIVENHAIN, CA, 92024, US

(21) Appl. No.: 11/237,676

(22) Filed: Sep. 29, 2005

(51) Int. Cl. B01D 47/00

(52) U.S. Cl. 55/400

(57) ABSTRACT

The present invention relates to a shop vacuum cleaner cartridge filter spinner, consisting of a turbine mount, a turbine impeller blade and a cartridge filter mount, assembled on an axle. The suction air stream through the shop vacuum cleaner and through the turbine rotates the cartridge filter on the filter mount of the filter spinner, creating centrifugal force on the outer surface of the rotating cartridge filter, which inhibits particles carried by the air from settling on the filter. This rotating action of the filter keeps the filter relatively clean, with air passage through the filter unobstructed, which prolongs the optimum function of the filter and reduces the frequency of necessary filter service. The shop vacuum cleaner cartridge filter spinner can readily be built into a new vacuum cleaner or retrofitted in existing vacuum cleaners.

### BACKGROUND OF THE INVENTION

The present invention relates to vacuum cleaners. In particular, the present invention relates to vacuum cleaners using cartridge filters, such as the canister shop vacuum cleaners used for sucking dirt, debris and material particles from floors and work areas.

Shop vacuum cleaners with round cartridge filters are ubiquitous in private homes, shops and institutions. While they are operated with a clean filter, the airflow through the filter is not obstructed by foreign particles, the power and volume of the suction of the vacuum cleaner at the intake nozzle is adequate. However, quickly, with continuous use the outer surface of the filter accumulates particles, such that the airflow is blocked and decreased with the vacuum cleaner loosing suction power and airflow volume at the intake. Each time the filter gets obstructed by particles of debris suction power decreases and the filter has to be cleaned or replaced. Consequently, operation of the vacuum cleaner has to be interrupted frequently with time lost and energy expended with the replacement of the filter, or cleaning the filter. Further, this frequent replacement of the filter adds to the cost of operating the vacuum cleaner. Prior art does not address the above-described round cartridge vacuum filter clogging problems adequately.

To avoid the frequent interruption of the round cartridge filter vacuum cleaner operation and to reduce the cost of operating the vacuum cleaner, the particles being carried by the air into the vacuum cleaner must be kept from landing and building up on the filter surface. This can be accomplished by rotating the filter during operation, such that the centrifugal force created at the surface of the filter, by its rotation, prevents particles from landing on the rotating surface of the filter.

Accordingly, it has been deemed desirable to develop a system for rotating the cartridge filter, such that the cartridge filter rotates while the vacuum cleaner is operating. Preferable is a cartridge filter spinner that can be built in new vacuum cleaners or retrofitted in the thousands of vacuum cleaners now in use, at a low cost, and with advantageous overall results. The present art addresses exactly this problem with the novel shop vacuum cleaner cartridge filter spinner invention.

### BRIEF SUMMARY OF THE INVENTION

According to the present invention, a novel shop vacuum cleaner cartridge filter spinner is provided.

In accordance with the invention, a shop vacuum cleaner cartridge filter spinner is provided, which includes a spinner motor mount, a motor and a spinner filter mount. The spinner filter mount, is rotationally driven by the motor fixed to the spinner motor mount. attached to the spinner filter mount via the driveshaft from the spinner motor. The rotation of the motor driveshaft with the attached spinner filter mount carrying the cartridge filter, creates centrifugal force at the surface of the filter, inhibiting particles, carried by the passing air, from landing on the surface of the filter.

In situations where the cartridge filter is covered by particles before the vacuum cleaner is operated, the cartridge filter spinner with the cartridge filter mounted on the spinner filter mount can be operated by itself, to rid the filter surface from most of the particles. In fact, the cartridge filter spinner can be used independent of the vacuum cleaning operation to clean filters by spinning them.

It is therefore an object of the present invention to provide a vacuum cleaner cartridge filter spinner, which when operated in a vacuum cleaner keeps the filter surface relatively free of particles. Further, it is an object of the present invention to provide an inexpensive vacuum cleaner cartridge filter spinner for new vacuum cleaners. Still further, it is an object of the present invention to provide an inexpensive vacuum cleaner cartridge filter spinner for retrofitting existing vacuum cleaners. And still further, to provide a vacuum cleaner cartridge filter spinner, which can be installed with minimum effort and at a low cost. These and other objects will become increasingly apparent to those skilled in the art by reference to the drawings and further explanations.

### DESCRIPTION OF DRAWINGS OF THE INVENTION

The accompanying drawings are incorporated in and constitute a part of this description of the invention, they serve to example the principles of this invention.

FIG. 1 is a side cross-sectional view along the vertical axis of the cartridge filter spinner in accordance with the present invention.

FIG. 2 is a top plan view of the cartridge filter spinner motor mount.

### DETAILED DESCRIPTION OF THE INVENTION

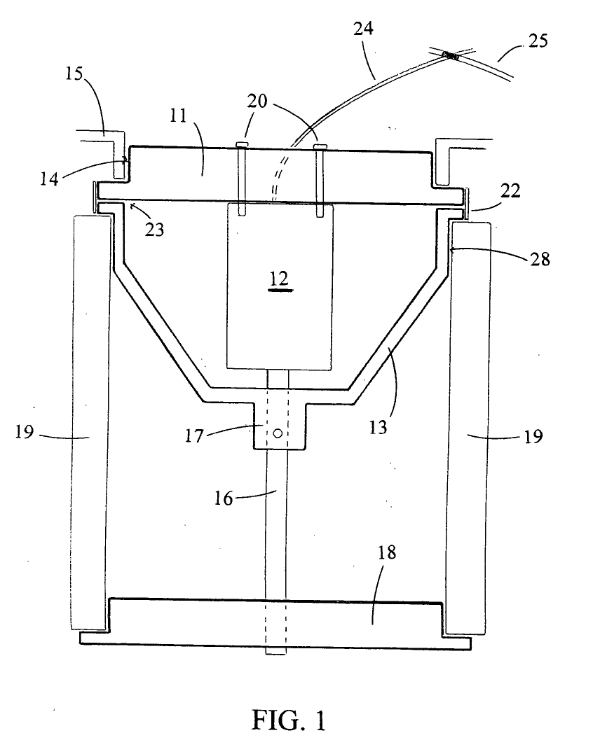

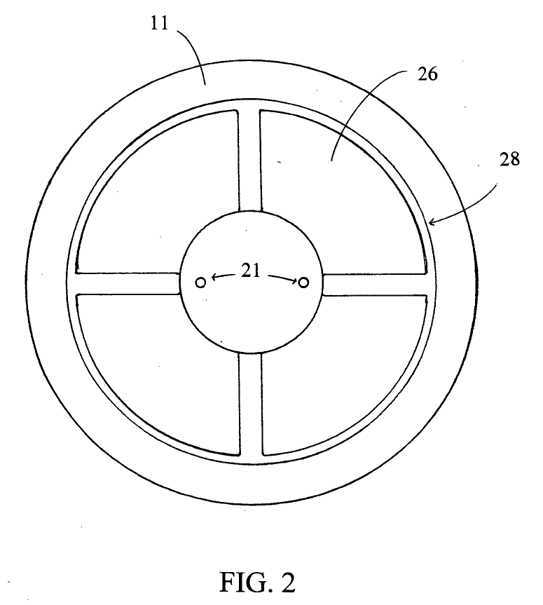

Referring now to the FIGURES, the showings are for purposes of illustrating preferred embodiments of the invention only and not for limiting the same. FIG. 1 illustrates a side cross-section along the vertical axis of the assembled parts of the cartridge filter spinner, while FIG. 2 show the cartridge filter spinner motor mount from a top plan form perspective.

Referring to FIG. 1, we can see the spinner motor mount 11 attached to the power unit filter mount 15 at the spinner motor mount and power unit mount interface 14, while the motor 12 is fixed to the spinner motor mount 11 by the motor mount fasteners 20. Continuing, the spinner motor mount 11 and the spinner filter mount 13 are held to each other, via the driveshaft 16 by the driveshaft coupling 17, such that the spinner filter mount 13 is free to rotate about the spinner motor mount 11. In this assembly a narrow space is left at the spinner motor mount and spinner filter mount interface 23, to provide free rotation.

The motor 12 (FIG. 1) is attached to the spinner motor mount 11 with the motor mount fasteners 20 through the provided motor mount fasteners holes 21 (FIG. 2) of the spinner motor mount 11, such that it is fixed firm.

Continuing with FIG. 1, to prevent dust from entering the filtered air stream, after the filter cartridge filter 19, at the spinner motor mount and spinner filter mount interface 23, a flap seal 22 is attached to the spinner motor mount 11 but not the spinner filter mount 13, such that it overlaps the spinner motor mount and spinner filter mount interface 23. During vacuum cleaner operation the air pressure is greater on the outside of the flap seal 22 and lower on the inside of the flap seal 22, with the difference in air pressure being sufficient to press the flap seal 22 against the outer circumference of the spinner filter mount 13, sealing the spinner motor mount and spinner filter mount interface 23 from dust particle penetration.

The power cord to the motor 24 (FIG. 1) travels through the air passage 26 (FIG. 2) and through the vacuum cleaner lid 25 (FIG. 1). The power supply to the cartridge filter spinner motor can be independent of the vacuum cleaner power supply, with its own switch, or it can be directed through the same switch as the vacuum cleaner.

The top view of the spinner motor mount 11 (FIG. 2}, which is similar to the top view of the spinner filter mount 13, illustrates that there is adequate air passage through the system for the operation of the vacuum cleaner.

Referring now to FIG. 1, the cartridge filter 19 is installed on the spinner filter mount 13 and held in place by the filter retainer 18, which can be tightened against the mounted filter 19 via matching threads on the driveshaft 16 and the filter retainer 18.

Again, referring to FIG. 1, to review the workings of the cartridge filter spinner invention, the cartridge filter spinner is attached to the vacuum cleaner at its regular power unit filter mount 15, at the spinner motor mount and power unit mount interface 14. When power to the cartridge filter spinner is turned on, the motor 12 spins the spinner filter mount 13 attached to the driveshaft 16 of the motor 12. The mounted cartridge filter 19, between the spinner mount 13, at the filter and spinner filter mount interface 28 and the filter retainer 18, the cartridge filter 19 spins along with the spinner filter mount 13 causing centrifugal force to operate at the surface of the cartridge filter 19, thus throwing off particles and preventing particles from landing.

The preferred materials to be used for the manufacture of the cartridge filter spinner and all its parts could be any that produce satisfactory results at a low cost, such as molded plastics, but not limited to plastics or any other material.

The invention has been described with detailed reference to the preferred embodiments. Obviously there will occur, possible modifications and alterations, to others reading and understanding the preceding detailed description. It is intended that the invention be construed as including all such possible modifications and alterations insofar as they come within the scope of the claims or the equivalents thereof.

What I claim as my invention is:

1. A vacuum cleaner cartridge filter spinner, for rotating cartridge vacuum cleaner filters, to remove dust particles, dirt and debris from the surface of the cartridge filter and to prevent particles from landing and accumulating on the filter while the vacuum cleaner is being operated.

2. A vacuum cleaner cartridge filter spinner as claimed in 1, wherein the vacuum cleaner filter spinner may be installed in an existing vacuum cleaner as a retrofit.

3. A vacuum cleaner cartridge filter spinner as claimed in 1, wherein the vacuum cleaner filter spinner may be manufactured as part of a new vacuum cleaner.

4. A vacuum cleaner cartridge filter spinner as claimed in 1, wherein the vacuum cleaner filter spinner accommodates the original vacuum cleaner filters.

5. A vacuum cleaner cartridge filter spinner as claimed in 1, wherein the vacuum cleaner filter spinner accommodates specifically designed filters.

6. A vacuum cleaner cartridge filter spinner driven by an electric motor.
